(19) United States
(12) Patent Application Publication
(10) Pub. No.: US 2017/0024358 A1
(43) Pub. Date: Jan. 26, 2017

(54) METHOD OF PROCESSING STATISTICAL DATA

(71) Applicant: Biometrix Pty Ltd, Eveleigh (AU)

(72) Inventor: Edward Simon DUNSTONE, Alexandria, New South Wales (AU)

(73) Assignee: Biometrix Pty Ltd., Eveleigh (AU)

(21) Appl. No.: 15/302,455

(22) PCT Filed: Apr. 14, 2015
(86) PCT No.: PCT/AU2015/000218

§ 371 Date: Oct. 6, 2016

(30) Foreign Application Priority Data
Apr. 15, 2014 (AU) 2014901377

(51) Int. Cl. G06F 17/18; G06N 99/00; G06F 17/30

(52) U.S. Cl. CPC G06F 17/18; G06F 17/30554; G06N 99/005

(57) ABSTRACT

A method of performing statistical analysis, including outlier detection and anomalous behaviour identification, on large or complex datasets (including very large and massive datasets) is disclosed. The method allows large statistical datasets (which may be distributed) to be analysed, assessed, investigated and managed in an interactive fashion as a part of a production system or for ad-hoc analysis. The method involves first processing the data into histograms and storing them in a manner that is capable of rapid retrieval. Then these histograms can be manipulated to provide conventional statistical results in an interactive manner. It also provides a method whereby these histograms can be updated over time, rather than being re-processed each time they are to be used. It has particular benefit to two class probabilistic systems, where results need to be assessed on the basis of false-positives and false-negatives.

### BACKGROUND

Statistical analysis tools for small and large datasets have been available to the computer industry for decades. Some of these tools are available as open-source frameworks and others are proprietary.

As an example, in the processing of complex or large data sets (including very large and massive datasets), for the purposes of biometric security or matching, biometric data (i.e. information related to a person's physical characteristics, such as face, iris, fingerprints, voice, etc.) is captured along with non-biometric data and included in the datasets.

These tools perform statistical analyses in order to obtain information about trends in the data as well as to produce metrics about the datasets such as the probabilities of false positives (where a data match is incorrect) and false negatives (where a correct match was not obtained).

Sometimes these datasets are distributed across many computers in a common location or across a wide area network which may extend to multiple states and countries.

These conventional tools need to process all of the data in order to perform these analyses. Open-source approaches, such as Apache Hadoop and Google MapReduce, look to maintaining certain aspects of these large distributed databases in a more efficient form, but do not utilise the histogram approach of the described methods.

Other tools achieve efficiency by utilising a statistically relevant sub-set of the dataset, but, in so doing, are likely to not include the very small number of problem data items that are most of interest in systems such as the hypothesis testing frameworks used for biometric matching which measure accuracy using Type I and Type II errors.

Detailed analysis of large datasets requires multiple analyses to provide different views or perspectives of the data. Each view requires reprocessing all, or large subsets, of the statistical data. Consequently, existing packages use very large amounts of computer resources and generally need to be operated by skilled professionals or academics.

Approaching statistical analysis in this way isn't able to form a real-time component of a production system either for regular standard reporting or for investigation of issues, persons-of-interest or other anomalies within the systems.

Such activity involves looking at many different scenarios and requires significant reprocessing of the data and generally limits the number of alternatives that can be realistically analysed. With this approach it is not possible to look at every possible combination and can't realistically be used interactively, especially by a person without a detailed background in statistical analysis.

These approaches can't permit exhaustive analysis of every possibility that needs to be assessed, and, where only subsets of the data are used, it is highly likely that the very small number of critically important items of data will be missed. The retention of these critically important items within a dataset will lead to the identification of security or performance issues and the detection of anomalous system behaviour.

Many biometric systems form a part of national security, provide access to visas, passports, drivers' licenses and other forms of identification and allow access to bank accounts and other areas of privacy. Reducing or eliminating the potential for fraud and mismatching is a critical role of statistical analysis in these systems and it is critical that such analysis be performed on all, not just a subset, of the datasets.

It is also important to consider that these datasets will contain private data. Where statistical analysis requires access to the whole of the dataset, privacy can be compromised, so a methodology which permits this information to be privatised prior to analysis has significant privacy and security benefits.

System analysis is currently required to be done by experts skilled in the art of understanding statistical analysis and complex data mining or analysis tools. Tools to facilitate such investigation often do not account for data that includes probabilistic information or allow for interactive collaboration. To account for increased volumes and complexity of systems that include probabilistic data, new ways of presenting analysis data that both allow interactive real-time visualization with drill down as well as social collaboration are required to enhance diagnostic and investigation ability.

### SUMMARY

It is an object of the present invention to substantially overcome, or at least ameliorate, one or more disadvantages of existing arrangements.

According to a first aspect of the present disclosure, there is provided a method for efficient processing of statistical data by constructing histograms of the data to rapidly determine outliers and search for patterns of anomalous performance.

According to a second aspect of the present disclosure, there is provided a method to enhance the accuracy and performance of a system by determining which specific items of interest or attribute specific groupings would benefit from localized thresholds and the value of these thresholds.

According to a third aspect of the present disclosure, there is provided a method of displaying analysis or investigation information that can be used for collaboration among a team for analysis and investigation of system issues or of specific items of interest.

According to another aspect of the present disclosure, there is provided a method for efficient processing of complex or large data sets of statistical data by constructing groups of histograms for every item of interest and attribute of the data thus allowing the automatic determination of anomalous behaviour or outliers in large or extremely large data probabilistic data sets by using efficient histogram representation of items of interest and exhaustive search techniques.

### BRIEF DESCRIPTION OF THE DRAWINGS

FIG. 1 is a block diagram of a non-limiting example system;

FIG. 2 is a flow chart example of the overall logic of the histogram creation;

FIG. 3 is a non-limiting plot of attribute histograms per item of interest;

FIG. 4 is a diagram showing the display of interactive and collaborative analysis tiles.

### DETAILED DESCRIPTION INCLUDING BEST MODE

The specific items of interest in the system to be measured must first be predefined. These items of interest represent the primary unit on which measurements within the system are being made. The items of interest may also have attached to them metadata that describes the fixed properties of that item. For each unique item of interest there will also be one or more scalar attributes that are to be measured at different points in time or under different measurement conditions. Each measurement may also have non-scalar metadata available. In one example, the item of interest may represent a person, the attributes are biometric matching scores and the metadata is the date of birth and the gender. Such a person would have a Unique ID.

For each attribute to be measured it is desired to be created a probability density function as represented by a histogram. An optimal binning strategy for this histogram can be determined by understanding the bin size and the fundamental scale (e.g. logarithmic or linear) leading to a binning formula which takes a sampled attribute value and returns a bin number. Where appropriate test data is available this can be used to sample and determine such properties empirically using well-known techniques.

Using the attribute statistic described above a data structure combining the histogram and metadata is defined. The data structures for each item of interest have two forms depending on processing requirements.

1) Using a separate storage location for each bin. This is appropriate for processing on dedicated hardware that allows vector processing, such as a Graphics Processing Unit;

2) An indexed data structure using the Unique ID and bin number, and optionally a quantized time, as indexes. The information stored in the histograms is generally sparse (having many zeros) this thus allows a compact representation which is still able to be rapidly accessed. It also does not require explicit limits placed on the histogram range. The binning strategy is defined by a function ƒ_{b} which transforms a measurement m into a bin number b: b=ƒ_{b}(m). If the function ƒ is complex or highly non-linear it may be implemented as a look up table. The limits are only then based on the limit of the bin index b. Where the data is to be sampled across a range of times the index can include a quantized time, such that this time period represents a granular view of a statistically relevant data period. If the quantized time t is represented as q then the function ƒₜ computing the time q=ƒₜ(t). The index i_{uid,m,t} for an item of interest with Unique ID uid, measurement m at time t is then given by the concatenation (not summation) of the fields

i_{uid,m,t}=uid+ƒ_{b}(m)+ƒₜ(t)

Each count in the histogram represents a reference to some event or other item of interest. A reference to this event or item can hence also be stored under the same index. This allows a quick drill down to look at the underlying attribute data that has contributed to the histogram. For one example, this allows the examination of what has contributed to an outlier. The selection of what records get stored in the reference can be controlled by business rules.

Both the representations described above permit measurements to be processed rapidly and efficiently without the need to ever fully recompute a histogram. The compact representation also allows this processing to be done in-memory rather than on-disk. In some cases transfer between these two forms may be necessary where the advantage of vector processing can be used but there is limited vector processing memory. In one example the main datastore is held in form 2 on the disk and transformed to form 1 for GPU processing for a given data partition.

Such histograms can be extended in real-time as additional data is obtained for an attribute of an item-of-interest by simply incrementing the appropriate bin or bins. In one example, such an implementation can be put on a mobile device and the resultant data shared anonymously with a centralized monitoring system.

Histograms can be partitioned by date or time in order to keep a window of current information by allowing a decay of older histogram information, this also helps to prevent overflow. This equates to each histogram being split by a time quantization function as described above. In one example, each time index might be set to one week or one month. Histograms that are older than a predetermined time period can be deleted.

The system thus contains rapidly updatable and accessible histogram information for every item of interest across every measured attribute. When examining large datasets, useful insight comes from identifying those cases that are rare or do not conform to the general distribution expected for any particular group—these cases are known as outliers. Using the above data structures allows for extremely rapid identification of outlier conditions by searching for those items of interest where both there is a non-zero count for a bin, and, where this condition is rare, amongst the set or subset of items of interest histograms. It also allows identification of items of interest where the histogram distributions differ significantly from the average distribution by using statistical hypothesis testing techniques, such as the chi squared test, across all histograms in the group. Items of interest which have a high probability of being drawn from a different distribution indicates anomalous system behaviour.

Such anomalous system behaviour includes the real time identification of failing or underperforming sensory data by looking for outlier conditions in either quality or matching attributes. In one example this may look at image quality information coming from a fingerprint scanner or camera and determine that there is an outlier condition arising from a determination relative to other such sensors or based on previous time periods.

The use of these histograms, rather than the analysis of massive volumes of underlying data, permits analyses to be readily performed in distributed databases and across multiple servers. This provides the described technique with the ability to scale without significant loss in performance by adding computational resources. The data representation can also be readily separated from the underlying raw measurement data in such a way as to provide anonymity and privacy to the data analysis, whilst still retaining a high degree of granularity for analysis and processing.

If histogram storage is partitioned across multiple distributed devices or storage locations that may be independently updated, it is important to be able to accomplish synchronization in a simple and efficient manner. Each bin is only ever increased in value, so this allows such histogram synchronization to be accomplished without loss of information by taking the maximum value in each bin for each server n.

b_{uid,m,t}=max(b(1)_{uid,m,t},b(2)_{uid,m,t} . . . b(n)_{uid,m,t})

Once the histograms are available they can be processed like matrices to obtain conventional statistical results using a small fraction of the effort currently used for statistical analysis on the raw data. This is particularly evident where attributes are measuring Type I and Type II errors. The creation of receiver operating curves (ROC curves) that allow the detection thresholds to be set are trivially computed from the histogram groups by converting them to probability density functions. The statistics determine average values across the bin so approximation errors for generated statistics can be introduced where determination of Type I or Type II error values between the histogram bins is required. In practice careful selection of binning parameters minimizes any error.

By looking at collective, or individual, statistics, appropriate thresholds can be determined and monitored on a per-group or individual basis. This allows granularity of control on events that might cause Type I or Type II errors. In current systems thresholds are usually applied to every item of interest regardless of any relevant specific attributes. In one example, for a biometric system, a particular group may always be more likely to trigger an investigation as the people have more similarity in their traits than the average population. Groups requiring such adjusted thresholds, and the thresholds, can be determined and monitored using the described technique. This allows for the optimization and setup of a system involving biometric data including setting the thresholds.

The determination of poorly performing attributes of a probabilistic system, as described above, can also be used to benchmark risks in a current system. Risks identified can be input to an overall system risk analysis framework or product.

Using the available metadata relevant histograms can be created at any or all levels of granularity. In one example, this allows decision trees to be rapidly built that explore almost every possible combination of metadata for large datasets in near real-time. In another example, machine-learning and clustering techniques can be used to examine these representations of the underlying data in order to obtain inferences about the data and detect artefacts that may point to aberrations and issues in the data.

Efficient and fast visualisation techniques can be used on the histograms to permit additional insights to be obtained. This utilises the ability to display individual or collective statistics of the attributes on two or more axes. In one example, the x-axis is the average Type I error (false accept) and the y-axis is the average Type II error (false reject). A point is plotted for each item of interest and the display of each point may be varied to show information on the group membership for this item. This provides a visual way to show outliers and combined with real-time interactive visualization can provide insights into system performance not available from standard statistical presentations.

The above technique can also facilitate the comparison of datasets or systems at different times and/or based on different methodologies. The difference between the distributions of items of interest allows an understanding of the effects of different operational environments on system performance.

A method to allow rapid human assessment of system issues and identification of outliers is also proposed. This can be applied for the output of the statistics, either using the above-described technique or other analysis tools. This uses statistical assessment techniques to select a number of aspects about system performance at a variety of levels of granularity. The method of ranking what visualizations are shown, involves the measurement of system outlier conditions, business rules and risk assessment.

These granular levels are shown as a series of tiles that can slide in all directions. The sliding left to right allows examination of the different system attributes, and up and down to show different granularity on those attributes (or attribute combinations). At the base level of granularity an investigator may be looking at the individual record details. This can provide a natural way to limit permissions for a given investigator by setting the lowest level of granularity allowed.

Where there are a number of individuals using the analysis tool they may collaborate by marking any particular analysis tile as of higher or lower importance, or by tuning the parameters for a given tile. This affects the display, ranking and order shown to other collaborators in real-time allowing an overall consensus view of system operation, outliers or investigation, to emerge. This can be particularly valuable where the analysis involves investigation of outlier events or fraud. In one example this would allow a system using face recognition to allow operators to drill down and refine the view to rapidly identify the highest risk individuals for further investigation.

Biometric systems are probabilistic by nature, due to the inherent variability of biometric samples. No two presentations of a biometric will ever be identical. Risk management of such a system requires that continual monitoring be undertaken to identify outlier situations, identify fraud, protect against vulnerabilities and monitor the acquisition environment. One example of such a system is a large-scale speaker verification system used to verify individual identity and detect fraud. In such a system there are a large range of input attributes and matching scores that are continually generated as people call and attempt to authenticate. Using the described techniques, vulnerabilities can be detected through outlier analysis, and system parameters can be tuned to increase security without increasing authentication failures. In another example, mobile devices with a fingerprint sensor are used for mobile payments. The mobile handset can collect histogram information about utilization and other attributes and transfer the anonymous data structure wirelessly to a central security monitoring system in which the analysis may be undertaken. This will allow likely fraud to be detected, provide enhanced risk management for corporations and provide opportunities for optimization of handset parameters to enhance usability without increasing risk.

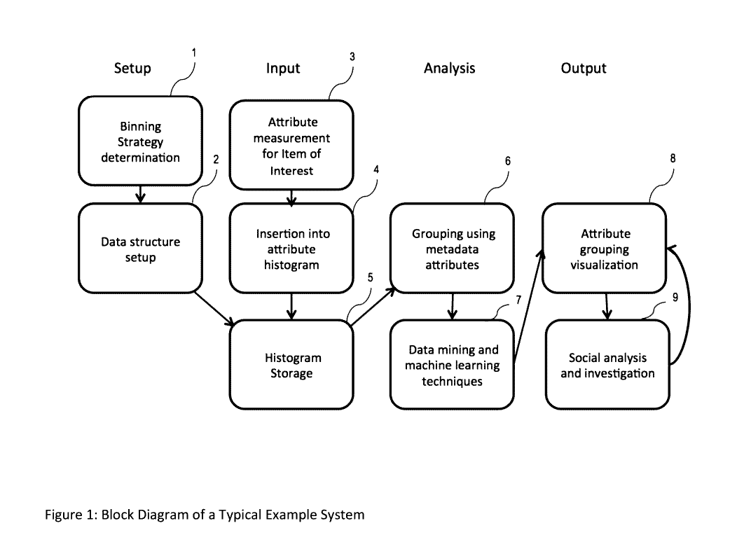

As seen in FIG. 1, the system starts at step 1 with an assessment of either the algorithm, or utilization of the extraction of existing data, to determine the range and scale of all measurement types. Optimal binning may involve the selection of non-linear scales in order to reflect the maximum sensitivity in the histograms

The data can be structured as a matrix or using a hashed data structure that uses both the Unique ID (of the person) and the bin as the index to the histogram count. The hashed data structure is more effective in most cases since many bins will be zero. It also removes the need for pre-determined bin ranges to be defined. Each existing identity requires the metadata to be established. As represented in step 2 of FIG. 1 this may be referenced from its existing database location outside of the histogram data store where it is desired to avoid duplicating identity information.

A biometric system can create many attributes or measurements as part of each recognition or identification. A large system may have many different sensors and many different user types. For instance, fingerprint sensors used for mobile e-commerce on mobile phones have a separate biometric reader on each phone and users that may come from any demographic group or with disabilities. Examples of such measurements include matching scores; liveness assessments; environmental measurements and quality attributes for every biometric sample acquired as represented in step 3 of FIG. 1.

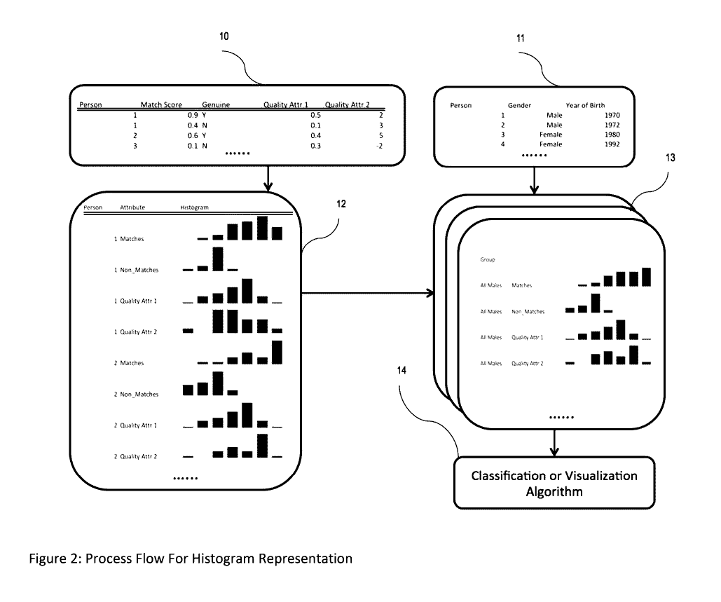

When one or more measurements arrives from the biometric system it is quickly updated by looking up its index and incrementing the appropriate bin as represented in step 4 of FIG. 1 and steps 10 and 11 of FIG. 2. The data store holding the histograms can be held partially or fully in memory, on disk or distributed across many computing units as represented in step 12 of FIG. 2. For mobile devices or systems the data store can be held on the device and shared anonymously. Synchronization between computing resources can be achieved using the differential between the previously synchronised histogram and the new histogram summed across each distributed group as represented in step 5 of FIG. 1. Histograms can be partitioned also by date to allow decay of older histogram information to prevent overflow.

When the store is operational the histograms can be quickly summed in any grouping determined from the available metadata as represented in step 13 of FIG. 2. Due to the rapid calculations, exhaustive searches can be conducted of the most likely parameter space as represented in step 6 of FIG. 1. A variety of statistical techniques can be applied to the output groupings including statistical techniques that look for relationships between attributes and performance measures, or supervised or unsupervised machine learning techniques, to automatically find patterns and relationships in the data as represented in step 7 of FIG. 1 and step 14 of FIG. 2.

One approach to finding relationships between attributes and performance measures is by computing their correlation coefficient between every distribution. Correlation measures the strength of the linear relationship between two variables. If the correlation is positive, an increase in one variable indicates a likely increase in the other variable. A negative correlation indicates the two are inversely related. In one example, a negative correlation between age and template quality would indicate that elderly people are more likely to have poor quality enrolments than young people.

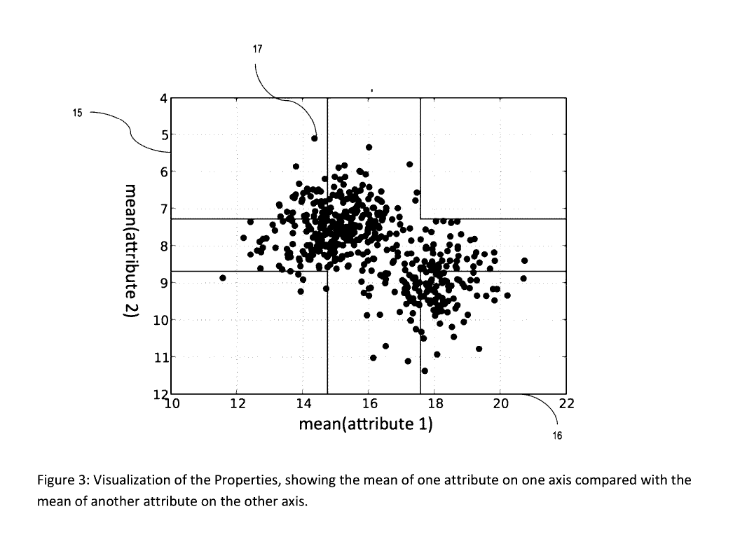

Even using the statistical and machine techniques available, the human visual system is still able to detect cases that are not possible to determine currently using an algorithm, provided the right tools or visualization techniques are available. The presentation of this analysis can be aided where the information is already represented in a form that can be rapidly reduced and manipulated. The histogram techniques described here provide an extremely efficient way to display the groups of individual items of interest by reducing the properties of the histograms to a form that can be displayed on attribute axes as represented in step 15 of FIG. 3. In one example, this may be histogram averages for each Item of interest with an X-Axis of Type I errors and a Y-Axis of Type II errors as represented in step 16 of FIG. 3. Different group types may be displayed using symbols or colours to differentiate between groups. This allows an operator to quickly identify groups that are performing differently or where fraud may be detected as represented in step 17 of FIG. 3. A third axis can be introduced to show another attribute. As the representation of all users is compact the axis types can be shifted or changed in real-time allowing the user to explore many aspects of system operation or drill down to specific instances as represented in step 8 of FIG. 1.

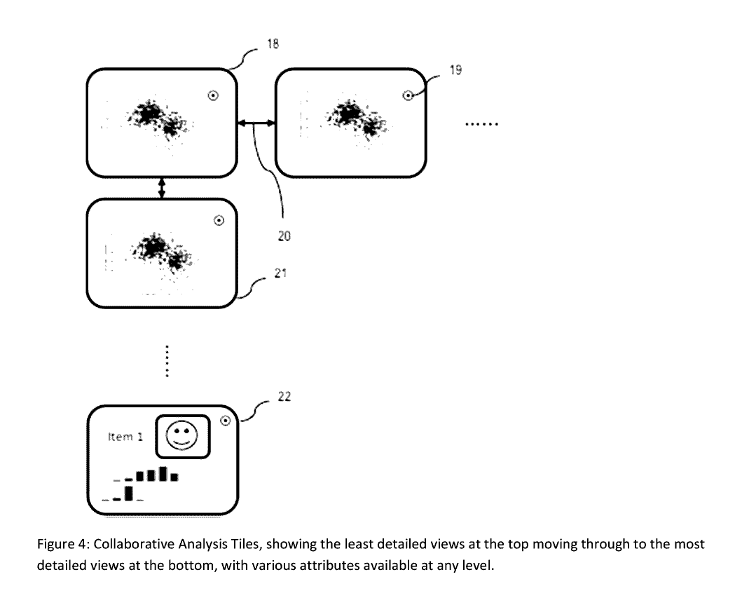

As the analysis of a system can include an exhaustive examination of all groups and subgroups, the resulting data insights can be ranked and provided back to the user as a series of tiles as represented in step 18 of FIG. 4. Each analysis tile provides one way of visualising the system statistics and allows collaboration and refinement of visualization parameters.

A sequence of data tiles can form a visualisation pathway. This pathway is a logical arrangement of data-tiles that provides a comprehensive overview of a large dataset over a number of attributes at different levels of granularity as represented in steps 18 to 22 of FIG. 4.

Where multiple investigators are involved they can vote on a particular tile to increase or decrease its relative importance as represented in step 9 of FIG. 1. A collaborative analysis button on each tile allows the users to customize and update the parameters associated with the visualization and change its relative priority for other users. Increasing a tile's priority moves it up the visualization pathway as represented in step 19 of FIG. 4. The voting can affect the position of the data-tiles in the visualisation pathway by moving them closer to the start of the visualization if they are voted as more important. This allows less skilled operators to undertake analysis and facilitates a consensus around these analyses. In one example, the operators move the tiles left and right to look at different system groupings and up and down to increase or decrease the granularity of the analysis Transitions between the tiles can be achieved quickly by a gesture such as a hand swipe, touch swipe or keyboard press as represented in step 20 of FIG. 4. As one moves down through the analysis tiles the level of granularity of the statistics increases as represented in steps 21 and 22 of FIG. 4.

1-14. (canceled)

15. A method for processing a biometric dataset comprising multiple items of interest with each item of interest having associated attributes and metadata, the method comprising:
constructing a histogram for the attributes of each item of interest using a binning strategy based on a determined bin size and fundamental scale;
constructing a data structure to allow the histograms for subsets of the metadata associated with each item of interest to be combined;
determining performance statistics for the biometric dataset using the data structure and histograms;
determining localized thresholds for one or more of the items of interest or associated attributes based on the determined performance statistics; and
determining an outlier in the dataset using the constructed histograms and data structure, based on the localized thresholds.

16. The method according to claim 15, further comprising performing drill down search techniques on the constructed histograms to view underlying attribute data and determine the outlier.

17. The method according to claim 15, further comprising:
determining the bin size for the histogram;
determining the fundamental scale; and
determining the binning strategy for the histogram based on the bin size and the fundamental scale.

18. The method according to claim 15, further comprising identifying vulnerabilities in the dataset using the constructed histograms and data structure.

19. The method according to claim 15, further comprising monitoring performance of the dataset using the constructed histograms.

20. The method according to claim 15, further comprising calculating performance statistics for a system using the biometric data.

21. The method according to claim 15, wherein the histograms are constructed of anonymous data.

22. The method according to claim 15, further comprising performing a risk analysis based on the determined outlier.

23. The method according to claim 15, further comprising identifying in real time failing or underperforming sensory data based on the determined outlier.

24. The method according to claim 15, wherein the dataset is a biometric dataset and the method further comprises optimizing setup of a system involving the biometric dataset and setting thresholds for the biometric dataset based on the constructed histograms.

25. The method according to claim 15, wherein the item of interest is a person and the attribute is at least one of a biometric matching or a quality score.

26. The method of claim 15, further comprising displaying analysis or investigation information for collaborative analysis and investigation of system issues.

27. The method according to claim 26, further comprising using voting to determine relative importance of the analysis or investigation information.

28. A system for processing a biometric dataset comprising multiple items of interest with each item of interest having associated attributes and metadata, the system comprising:
memory for storing data and a computer processor, the processor being configured for:
constructing a histogram for the attributes of each item of interest using a binning strategy based on a determined bin size and fundamental scale;
constructing a data structure to allow the histograms for subsets of the metadata associated with each item of interest to be combined;
determining performance statistics for the biometric dataset using the data structure and histograms;
determining localized thresholds for one or more of the items of interest or associated attributes based on the determined performance statistics; and
determining an outlier in the dataset using the constructed histograms and data structure, based on the localized thresholds.

29. An apparatus for processing a biometric dataset comprising multiple items of interest with each item of interest having associated attributes and metadata, the apparatus comprising:
means for constructing a histogram for the attributes of each item of interest using a binning strategy based on a determined bin size and fundamental scale;
means for constructing a data structure to allow the histograms for subsets of the metadata associated with each item of interest to be combined;
means for determining performance statistics for the biometric dataset using the data structure and histograms;
means for determining localized thresholds for one or more of the items of interest or associated attributes based on the determined performance statistics; and
means for determining an outlier in the dataset using the constructed histograms and data structure, based on the localized thresholds.
